(19) United States
(12) Patent Application Publication
(10) Pub. No.: US 2013/0306510 A1
(43) Pub. Date: Nov. 21, 2013

(54) PICTURE BOX AND CONTAINER

(71) Applicant: William M. SCOTT, Villa Hills, KY (US)

(72) Inventor: William M. SCOTT, Villa Hills, KY (US)

(21) Appl. No.: 13/896,859

(22) Filed: May 17, 2013

Related U.S. Application Data
(60) Provisional application No. 61/649,228, filed on May 18, 2012.

(51) Int. Cl. B65D 5/42; B31B 1/90

(52) U.S. Cl. CPC B65D 5/4233; B65D 5/4204; B31B 1/90
USPC 206/459.5; 229/162.1; 493/56; 493/84

(57) ABSTRACT

A box comprising first and second end walls, first and second side walls, and a bottom defining the box. At least one of wall is a double wall formed by folding a portion of a blank of continuous paperboard material over itself to form an inner wall and an outer wall. The outer wall has at least one opening therein for viewing a picture affixed to the inner wall. Also disclosed is a container comprising the box and a lid that fits over the box and closes the container, and a method for forming the box and container.

### CROSS REFERENCE TO RELATED APPLICATIONS

This application claims the benefit of U.S. Provisional Application 61/649,228, filed May 18, 2012, the disclosure of which is incorporated by reference in its entirety.

### FIELD OF THE INVENTION

The present invention relates to a box having at least one double wall formed by folding a portion of a blank of continuous paperboard material over itself to form an outer wall having at least one opening therein for viewing a picture affixed to an inner wall. The invention also relates to a container comprising a lid that fits over the box and closes the container, and a method for making the box and the container.

### BACKGROUND OF THE INVENTION

Various items, including documents, records, photographs, memorabilia, collectibles, shoes, clothing, household items, and the like, are packed and stored in cardboard boxes for storage, transportation and protection. Such boxes are packed and stored in homes, retail outlets, businesses and factories. The boxes may be stored for long periods of time and accessed infrequently. Multiple boxes having a similar appearance may store different types of items or items owned by different persons. Since cardboard boxes are not transparent, they do not allow for easy identification or classification of the contents by type of item, model, color, size or owner of the items stored therein. Such information may be written on the boxes, but this may not readily provide the desired information. Moreover, consumers and retail businesses may wish to personalize boxes containing special items for purchase, gifting or storage. Thus, there is a continuing need for a cardboard box that can help a person identify its contents or owner.

### SUMMARY OF INVENTION

The present invention relates to a box comprising first and second end walls, first and second side walls, and a bottom defining the box, at least one of said walls being a double wall formed by folding a portion of a blank of continuous paperboard material over itself to form an inner wall and an outer wall, the outer wall having at least one opening therein for viewing a picture affixed to the inner wall.

The invention also relates to a container comprising the above box and a lid that fits over the box and closes the container.

The invention further relates to a method for forming a box comprising first and second end walls, first and second side walls, and a bottom defining the box, said method comprising folding a portion of a blank of continuous paperboard material over itself so that at least one of said walls is a double wall comprising an inner wall and an outer wall, the outer wall having at least one opening therein for viewing a picture affixed to the inner wall.

### BRIEF DESCRIPTION OF THE DRAWINGS

FIG. I is a perspective view of a container and box according to the present invention.

FIG. 2 is an exploded view of the container of FIG. 1 showing the lid separated from the box.

FIG. 3 is another perspective view of the box in FIG. 3 showing detail of the structure of an end wall formed by folding a portion of a blank of paperboard material over itself to form an inner wall and an outer wall.

FIG. 4 is a perspective view of another box of the invention.

FIG. 5 is a plan view of blanks of continuous paperboard material used to form the container lid and box of FIG. 1.

FIG. 6 is a perspective view of another container and box of the invention.

FIG. 7 is an exploded view of the container of FIG. 6 showing the lid separated from the box.

FIG. 8 is another perspective view of the box in FIG. 6 showing detail of the structure of an end wall formed by folding a portion of a blank of paperboard material over itself to form an inner wall and an outer wall.

FIG. 9 is a perspective view of another box of the invention.

FIG. 10 is a plan view of blanks of continuous paperboard material used to form the container lid and box of FIG. 6.

### DETAILED DESCRIPTION OF THE INVENTION

The present invention relates to a box comprising first and second end walls, first and second side walls, and a bottom defining the box. At least one of said walls is a double wall formed by folding a portion of a blank of continuous paperboard material over itself to form an inner wall and an outer wall. The outer wall has at least one opening therein for viewing a picture affixed to the inner wall. The picture may be selected to help identify or classify the contents of the box by type of item, model, color, size or owner of the items stored therein. Consumers and retail businesses may wish to personalize and decorate boxes containing special items for purchase, gifting or storage.

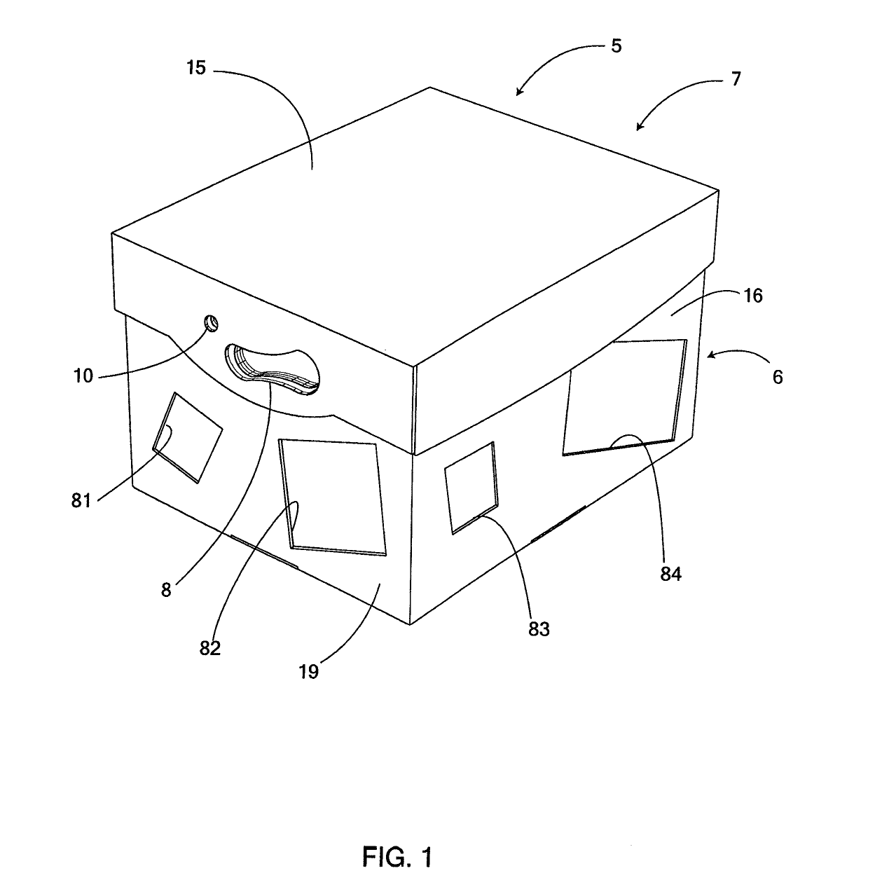

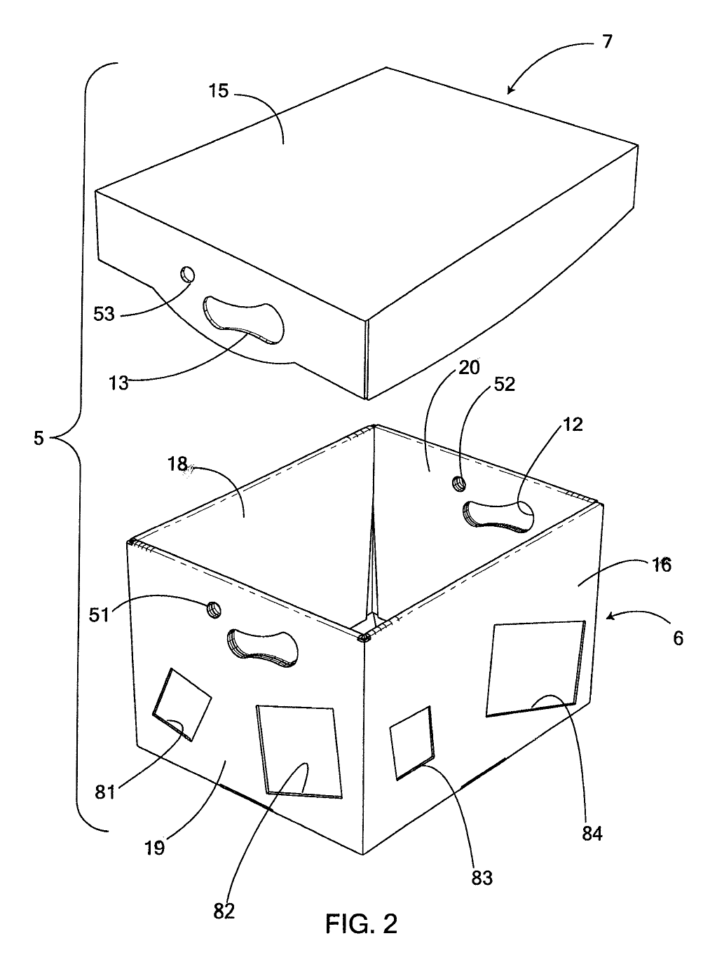

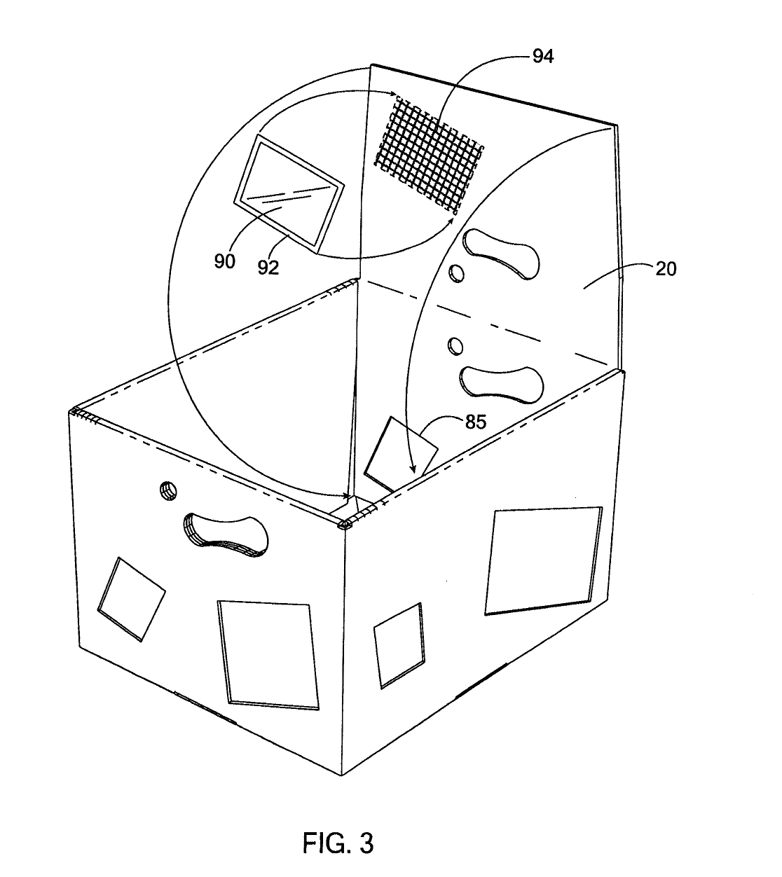

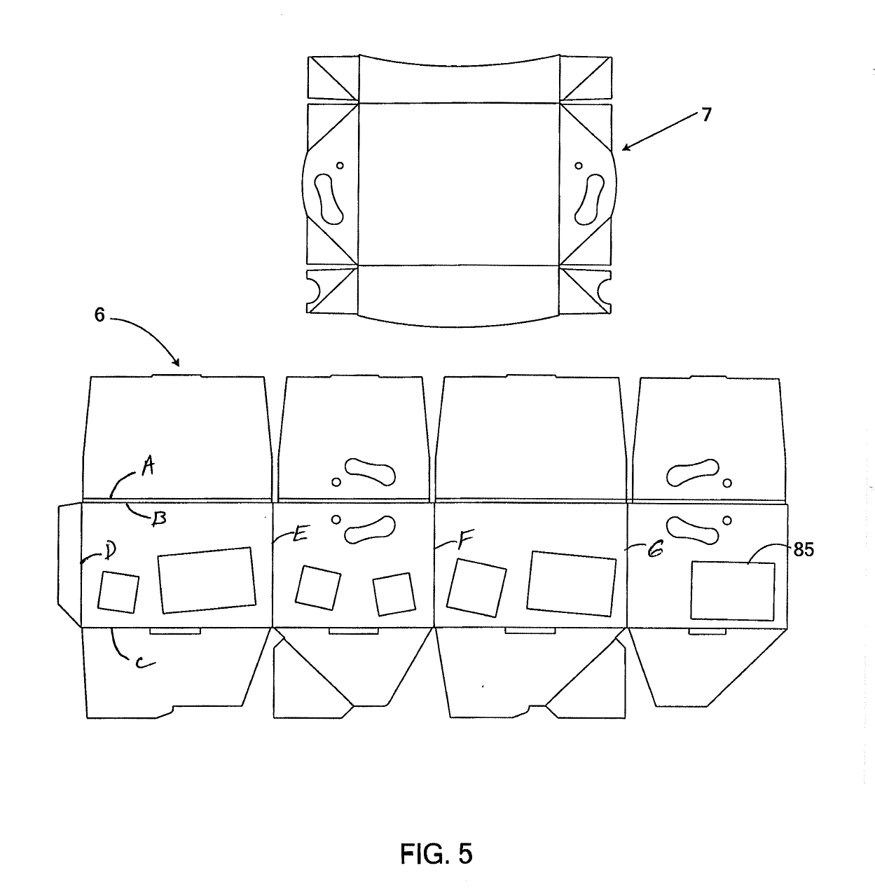

FIGS. 1-3 illustrate a container 5 comprising a box 6 and a lid 7 that fits over the box and closes the container according to one embodiment of the invention. Box 6 comprises opposed first and second end walls 19 and 20, and opposed first and second side walls 16 and 18, and a bottom (not shown, but formed by folding the walls along horizontal fold line C in FIG. 5 and gluing them together after folding along vertical fold lines D, E, F and G, as known in the art) defining the box. At least one of the end and side walls has a double wall formed by folding a portion of a blank of continuous paperboard material over itself, such as at horizontal fold lines A and B in FIG. 5, to form an inner wall and an outer wall. For example, in FIG. 3 end wall 20 is shown in a raised position prior to being folded over itself (at fold lines A and B in FIG. 5) to form a double wall. Typically, at least two of the end and side walls are double walls formed by folding portions of the blank of paperboard material over itself to form an inner wall and an outer wall. For example, end walls 19 and 20 or side walls 16 and 18 may have the double wall construction described above. More typically, all four of the end and side walls 16, 18, 19 and 20 are double walls formed by folding portions of the blank of paperboard material over itself to form the inner and outer walls. Such double walls further increase the strength and stackability of the boxes and containers herein.

As shown in FIGS. 1-5, the outer wall has at least one opening therein, such as openings 81, 82, 83, 84 and 85, for viewing a picture affixed to the corresponding portion of the inner wall. The opening may be any desired size and shape, for example, it may be rectangular, oval, circular, or irregular in shape. The outer walls of the box typically contain multiple openings, usually on multiple walls of the box. The openings typically are formed by die cutting the openings out of the blank of continuous paperboard material prior to folding and forming the box.

The picture may be photograph, typically in color, that enables a person to readily identify the contents of the box. The photograph may be applied in an automated process during construction of the box. For example, photo images may be transmitted to and printed on the associated die cut box pattern. Alternatively, the photograph may be inserted by the purchaser or user to personalize the box.

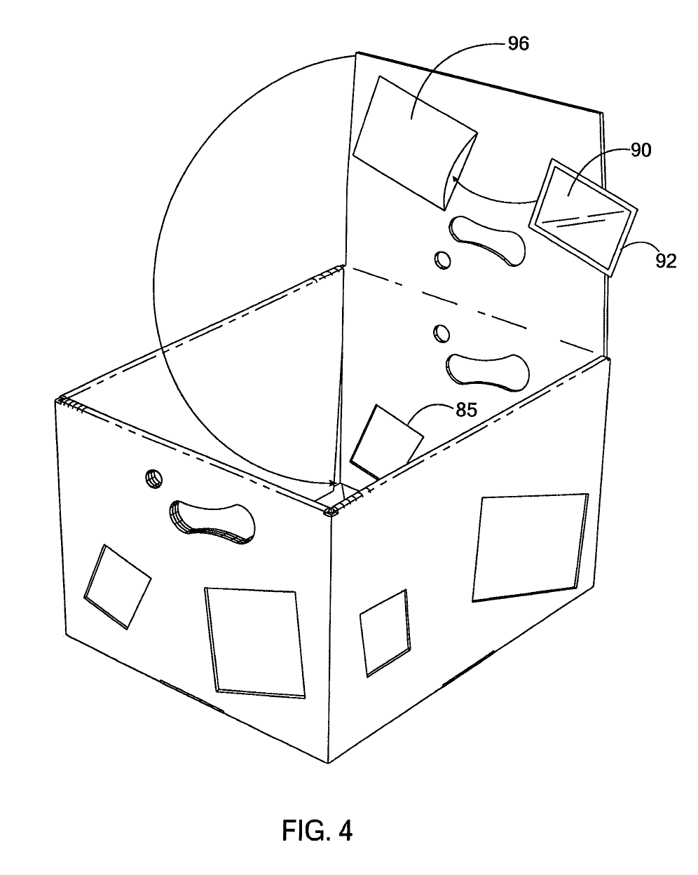

The picture may be permanently or removably affixed (e.g., attached, embossed or printed) on the corresponding surface of the inner wall of the box. The picture may be affixed to the inner wall using an adhesive material, such as adhesive tape or glue. For example, in FIG. 3, backing sheet 92 containing picture 90 is applied to adhesive layer 94 on the inner wall portion of wall 20 at a point corresponding to opening 85 in the outer wall portion of wall 20. In one embodiment, the picture is covered by a substantially transparent polymeric material, e.g. clear plastic material, to protect the picture from damage or wear and to provide a more finished appearance to the box. In another embodiment, the picture is inserted into a pouch made of a substantially transparent polymeric material, e.g., a plastic sleeve, affixed to the inner wall using an adhesive material, such as tape or glue. The picture may be removed and a new picture inserted in the pouch, as desired. For example, in FIG. 4, backing sheet 92 containing picture 90 is inserted into plastic sleeve 96 affixed to the inner wall portion of wall 20 at a point corresponding to opening 85 in the outer wall portion of wall 20.

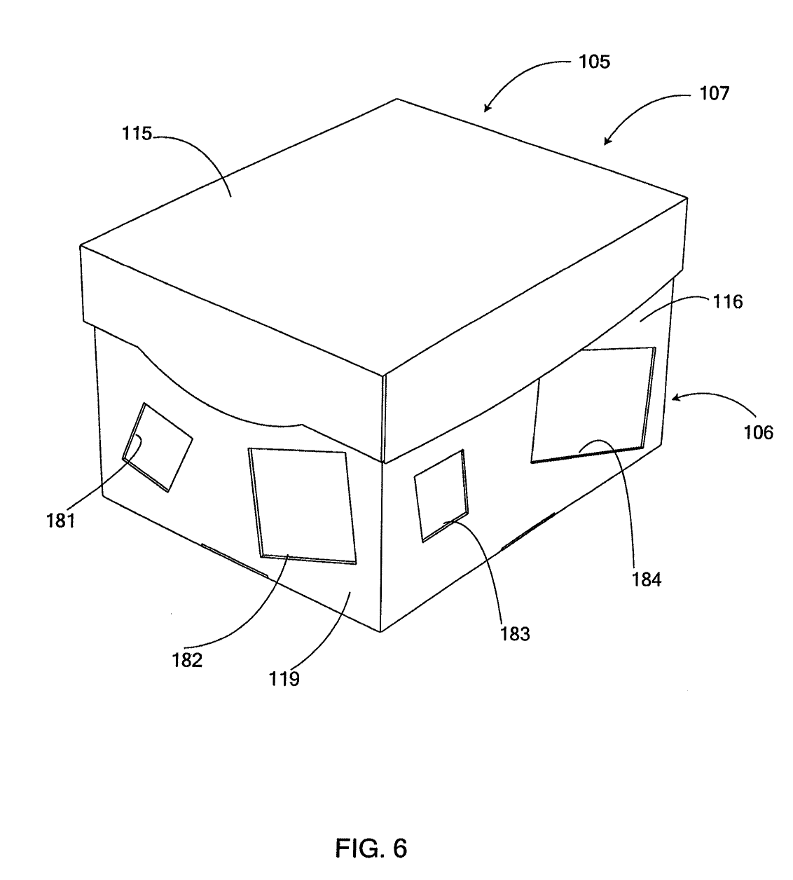

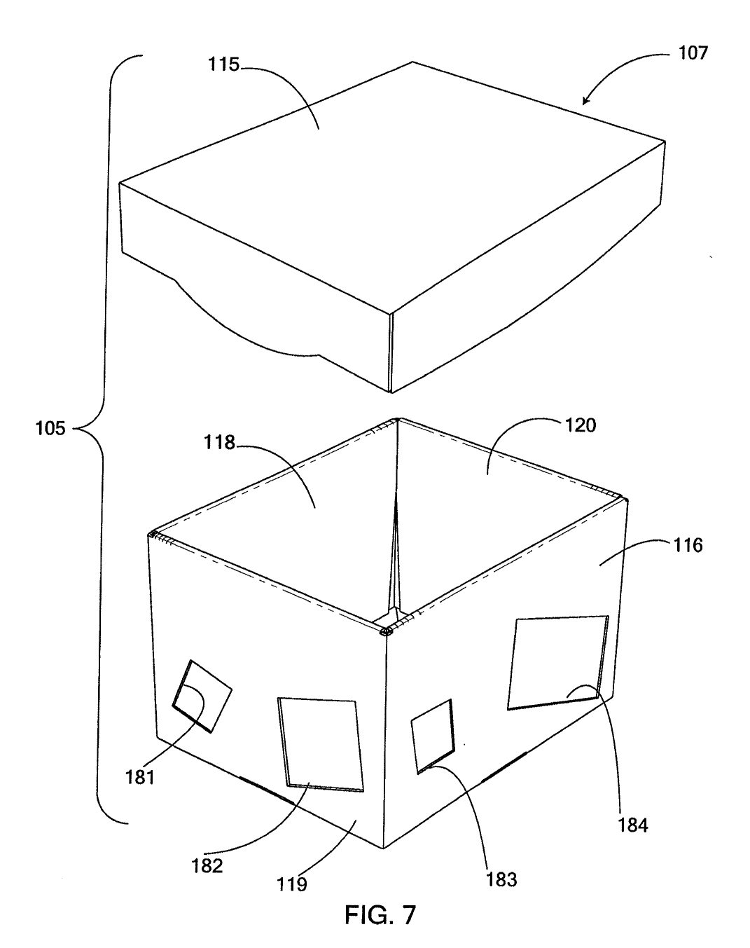

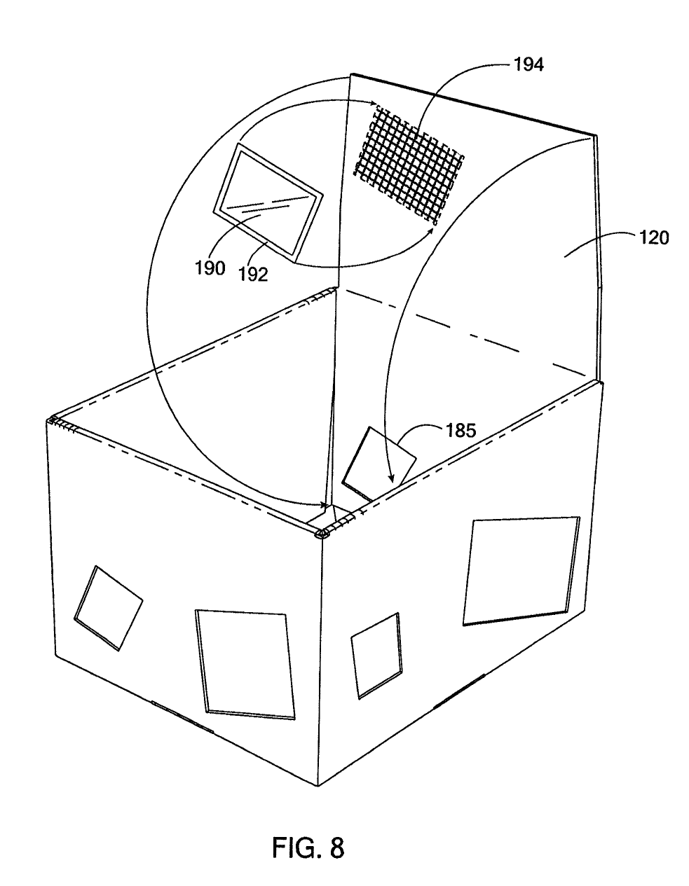

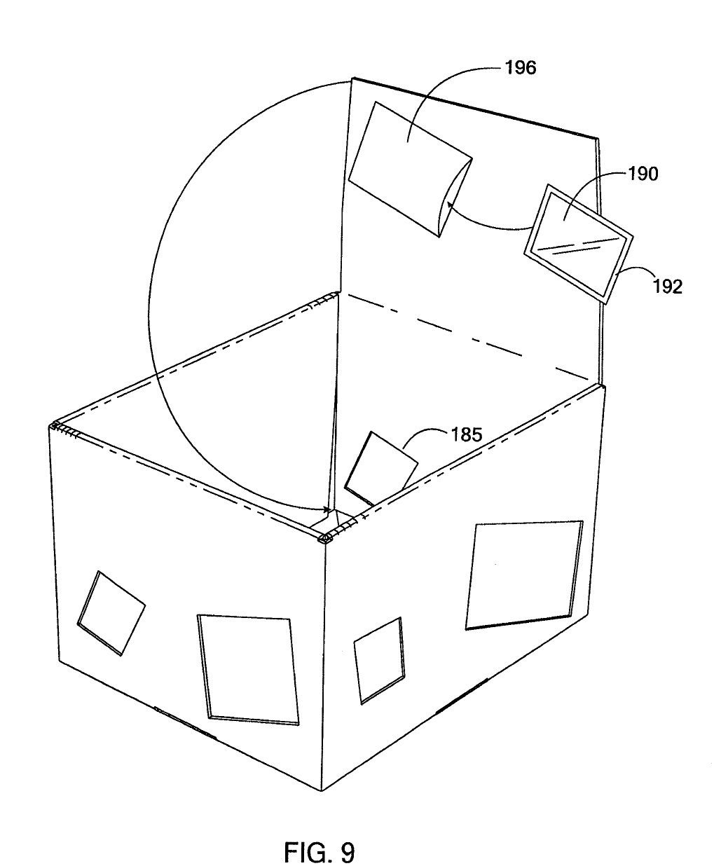

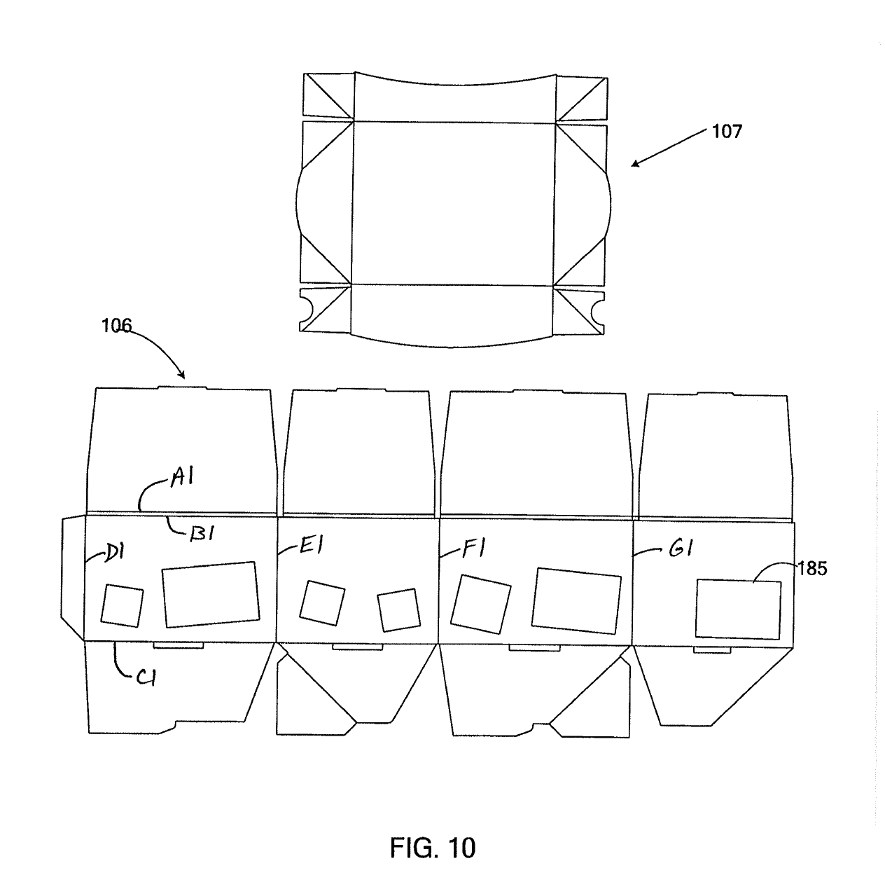

FIGS. 6-10 illustrate other containers, boxes and blanks of the invention similar to those in FIGS. 1-5 except not having the handles 8 and ports 10 therein. Similar elements are numbered similarly, except increased by 100.

The invention also relates to a method for forming a box comprising first and second end walls, first and second side walls, and a bottom defining the box, said method comprising folding a portion of a blank of continuous paperboard material over itself so that at least one of said walls is a double wall comprising an inner wall and an outer wall, the outer wall having at least one opening therein for viewing a picture affixed to the inner wall.

While various examples and embodiments of the invention have been shown and described, it is to be understood that the invention is not limited to these examples and embodiments, but encompasses any and all variations thereof within the scope of the following claims.

What is claimed is:

1. A box comprising first and second end walls, first and second side walls, and a bottom defining the box, at least one of said walls being a double wall formed by folding a portion of a blank of continuous paperboard material over itself to form an inner wall and an outer wall, the outer wall having at least one opening therein for viewing a picture affixed to the inner wall.

2. The box according to claim 1, at least two of said walls being double walls formed by folding a portion of a blank of continuous paperboard material over itself to form an inner wall and an outer wall, at least one outer wall having at least one opening therein for viewing a picture affixed to the inner wall.

3. The box according to claim 1, wherein the end walls and side walls are double walls formed by folding a portion of a blank of continuous paperboard material over itself to form an inner wall and an outer wall, at least one outer wall having at least one opening therein for viewing a picture affixed to the inner wall.

4. The box according to claim 1, wherein the picture is affixed to the inner wall using an adhesive material.

5. The box according to claim 1, wherein the picture is covered by a substantially transparent polymeric material.

6. The box according to claim 1, wherein the picture is inserted into a pouch made of a substantially transparent polymeric material that is affixed to the inner wall using an adhesive material.

7. The box according to claim 1, wherein the picture is a color photograph.

8. The box according to claim 1, wherein the end walls and side walls are double walls formed by folding a portion of a blank of continuous paperboard material over itself to form an inner wall and an outer wall, at least one outer wall having at least one opening therein for viewing a picture affixed to the inner wall, and wherein the picture is a color photograph affixed to the inner wall using an adhesive material.

9. The box according to claim 8, wherein the picture is covered by a substantially transparent polymeric material.

10. A container comprising (1) a box comprising first and second end walls, first and second side walls, and a bottom defining the box, at least one of said walls being a double wall formed by folding a portion of a blank of continuous paperboard material over itself to form an inner wall and an outer wall, the outer wall having at least one opening therein for viewing a picture affixed to the inner wall, and (2) a lid that fits over the box and closes the container.

11. The container according to claim 10, wherein the lid is affixed to the box.

12. The container according to claim 11 formed by folding a blank of continuous paperboard material.

13. The container according to claim 10, wherein the end walls and side walls are double walls formed by folding a portion of a blank of continuous paperboard material over itself to form an inner wall and an outer wall, at least one outer wall having at least one opening therein for viewing a picture affixed to the inner wall, and wherein the picture is a color photograph affixed to the inner wall using an adhesive material.

14. The container according to claim 13, wherein the picture is covered by a substantially transparent polymeric material.

15. The container according to claim 14, wherein the lid is affixed to the box.

16. A method for forming a box comprising first and second end walls, first and second side walls, and a bottom defining the box, said method comprising folding a portion of a blank of continuous paperboard material over itself so that at least one of said walls is a double wall comprising an inner wall and an outer wall, the outer wall having at least one opening therein for viewing a picture affixed to the inner wall.

17. The method according to claim 16, comprising the step of die cutting at least one opening in the outer wall.

18. The method according to claim 17, comprising the step of affixing the picture to the inner wall using an adhesive material.

19. The method according to claim 18, comprising the step of affixing a lid to the box.

20. The method according to claim 19, wherein the end walls and side walls are double walls formed by folding a portion of a blank of continuous paperboard material over itself to form an inner wall and an outer wall, and wherein the picture is a color photograph affixed to the inner wall using an adhesive material and the picture is covered by a substantially transparent polymeric material.
